(19) United States
(12) Patent Application Publication
(10) Pub. No.: US 2005/0273778 A1
(43) Pub. Date: Dec. 8, 2005

(54) List-bar interface control apparatus and method

(76) Inventor: Craig Bixler, Saint Charles, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/091,411

(22) Filed: Mar. 29, 2005

Related U.S. Application Data
(60) Provisional application No. 60/575,816, filed on Jun. 2, 2004.

(51) Int. Cl. G06F 9/44

(52) U.S. Cl. 717/165

(57) ABSTRACT

An enhancement to graphical user interface software adds training and customization features that allow users to select between levels of interface sophistication according to skill level. While pull-down menu functions and toolbar functions are commonly presented independently, the List-Bar interface control allows a user to present a menu and a toolbar together, including positional cues to further speed user familiarization with the toolbar's symbolic abstraction of menu terminology. A novice or occasional user can choose to use a menu alone, while an expert may prefer a toolbar alone. For a progressing user, having both modes displayed, active, and positioned in parallel can speed and reinforce learning. In addition to allowing direct arrow-key-class, mouse-class, and stylus-class pointing and selection tools, List-Bar interface control further directly supports touchscreen-controlled user interface, for which variable and generally more widely spaced selection element presentation on the display is accommodated.

### CROSS-REFERENCE TO RELATED APPLICATIONS

This application claims priority to provisional U.S. patent application entitled, “LIST-BAR INTERFACE CONTROL APPARATUS AND METHOD,” filed Jun. 2, 2004, having a Ser. No. 60/575,816, the disclosure of which is hereby incorporated by reference in its entirety.

### FIELD OF THE INVENTION

The present invention relates generally to user interface software for use in computing equipment. More particularly, the present invention relates to graphical user interface display methods for training and normal use.

### BACKGROUND OF THE INVENTION

It is known in computer user interface software to employ a variety of methods to provide access to computer functions. Because users with a broad range of skills may need to use particular software, greater or lesser levels of function integration may be included in software tools. Function integration can allow novice and occasional users as well as expert users to access computers as aids in the performance of tasks. Function integration can be provided in order to avoid errors, speed completion of tasks, and advance user proficiency.

It is further known in computer-based, graphical user interface (GUI) software to provide user access to functions via interface elements termed menus, by analogy to familiar functions such as restaurant service. Menus in some applications are known as pull-down or pop-up menus, in reference to the appearance of a display device in response to activation of a displayed category summary item that causes a normally hidden menu to be displayed. The pull-down or pop-up menu is in many configurations hidden again after the selection process is finished.

It is further known in computer-based, graphical user interface (GUI) software to provide user access to executable software functions via interface elements termed toolbars. In a toolbar, a region of a display, which may be organized as an oblong and contiguous region, presents one or more symbols representing the functions. User execution of a function represented on the toolbar can be realized in some systems by pointing, wherein a location selector such as a mouse-directed cursor is placed within a display zone associated with one symbol, and by subsequently providing an execution command, such as by clicking a switch on the mouse.

The two implementations, toolbars and menus, can meet operational requirements for software-based, hardware-dependent applications, but can each exhibit significant shortcomings. For example, a typical toolbar presents the functions with which it is associated in an extremely terse, even abstract, format, often with a single word, an abbreviation, or a symbolic picture known as an icon. As a consequence, the toolbar's functions may be readily available only to users sufficiently proficient to recognize an abstract symbol. A typical pull-down menu, in contrast, is likely to be slow and tedious for a proficient user, even though the same pull-down menu may be dauntingly complex to a novice or occasional user. Transition from pull-down menu use to toolbar use can be slow for a progressing user, since the two presentations can be furnished without reference to each other.

Accordingly, it is desirable to provide user interface software that coordinates and integrates toolbar and pull-down/pop-up menu functions, allowing users to accelerate their performance as they advance in proficiency.

### SUMMARY OF THE INVENTION

The above and other features and advantages are achieved in some embodiments by a novel combined toolbar and pull-down/pop-up menu or list function selection methodology, termed List-Bar User Interface Control, or list-bar, as herein disclosed. List-bar provides, when so selected by a user, one of a menu and a toolbar, wherein the two may in some embodiments have substantially similar or identical order and spacing in a display. A third user option is simultaneous, adjacent presentation of both the menu and the toolbar, so that a user can readily infer correlation between the two.

In accordance with one embodiment of the present invention, a method of displaying and processing information is presented. The method includes providing a group of elements for display on a display component of an interface subsystem of a computing device, wherein each of the elements represents an executable function in a program associated with the computing device, identifying a first class of elements within the provided group of elements, wherein the elements in the first class comprise a menu, identifying a second class of elements within the provided group of elements, wherein the elements in the second class comprise a toolbar, allowing function execution by element selection from either class by a user, and selectably concealing from presentation on the display component a class of selectable elements.

In accordance with another embodiment of the present invention, an information acquisition, maintenance, and display system is presented. The system includes means for displaying a group of elements on a display component of an interface subsystem of a computing device, wherein each of the elements represents an executable function associated with the computing device, means for selecting for execution an element from the group, means for differentiating between two display classes of executable elements, means for formatting a first display class as a menu, means for formatting a second display class as a toolbar, and means for choosing between displaying only the first display class, displaying only the second display class, and displaying both display classes.

In accordance with yet another embodiment of the present invention, a computer readable medium with program instructions for displaying and processing information is presented. The medium includes instructions for presenting a display image on a display component of an interface device whereupon are conditionally displayed at least two display elements, supporting selection-locus positioning and selection-locus activation hardware components of the interface device, and commanding execution of a function associated with a display element by selecting and activating the display element. The medium further includes instructions for identifying within the display image a menu display element, identifying within the display image a toolbar display element, establishing logic conditions enabling display of the menu element, establishing logic conditions enabling display of the toolbar element, providing user control of logic conditions for enablement of display of menu and toolbar elements independently of each other, and providing a mode in which menu and toolbar elements are displayed and enabled simultaneously.

In accordance with still another embodiment of the present invention, an information acquisition, maintenance, and display system is presented. The system includes a processing device, an input/output interface unit for the processing device, an information storage and retrieval unit providing modifiable record keeping for the processing device, and a processor-based instruction sequence actuating the processing device to control the interface unit and the information storage and retrieval unit. The system further includes an instruction sequence functioning as a user interface, wherein a group of user executable functions consisting of at least one of a menu having at least one item and a toolbar having at least one item is presented for user selection of a function to execute, wherein the menu and the toolbar provide substantially duplicated executable functions, and wherein placement of corresponding menu items and toolbar items is substantially parallel.

The input/output interface unit in the above information acquisition, maintenance, and display system further includes a processor-compatible touch-sensitive surface superimposed on the visible image presented on the display output device, wherein the touch-sensitive surface is configured to provide a data output signal representing a location on the surface on which a touch occurs, and wherein a mapping correlates the set of display elements and a set of touch-sensitive locations on the surface, whereby a touch applied to the surface is interpretable as both a position indication and an activation signal.

There have thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be used as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a screen display with a toolbar in accordance with the preferred embodiment of the present invention.

FIG. 2 is a screen display with a pull-down menu in accordance with the preferred embodiment of the present invention.

FIG. 3 is a screen display combining a toolbar and a menu in accordance with the preferred embodiment of the present invention.

FIG. 4 is a screen display like FIG. 1, adding a cursor, in accordance with the preferred embodiment of the present invention.

FIG. 5 is a setup screen display in accordance with the preferred embodiment of the present invention.

FIG. 6 is a secondary setup screen display in accordance with the preferred embodiment of the present invention.

FIG. 7 is a touchbar screen display in accordance with the preferred embodiment of the present invention.

FIG. 8 is a touchbar setup screen display in accordance with the preferred embodiment of the present invention.

FIG. 9 is a cascading screen display in accordance with the preferred embodiment of the present invention.

### DETAILED DESCRIPTION

The invention will now be described with reference to the drawing figures, in which like reference numerals refer to like parts throughout. A preferred embodiment in accordance with the present invention provides a software interface that furnishes at least one pull-down menu for selection of a function to be executed, using a presentation format appropriate to a menu, and further furnishes a pull-down toolbar in which the functions presented in each menu are repeated in substantially the same sequence, using a presentation format appropriate to a toolbar. This concept admits of several embodiments, each of which may be preferred in a specific operational environment.

The computer software indicates, in menu, toolbar, or combined mode, disablement of functions. Disablement is indicated by changing the representation from a fully functional default representation to a second, less prominent representation. For example, “graying out” a command can show that a function is unavailable, while continuing to display the unavailable function. “Graying out,” i.e., lowering foreground-background contrast, as well as other display variations, can be used to indicate that selection and activation of specific items has no meaning or is otherwise not permitted at a step and is therefore disabled.

List-Bar user interface enhancement is dynamic at least in the sense that a user can, by selecting access and control options consistent with a self-described level of proficiency, cause particular classes of controls to be presented or hidden.

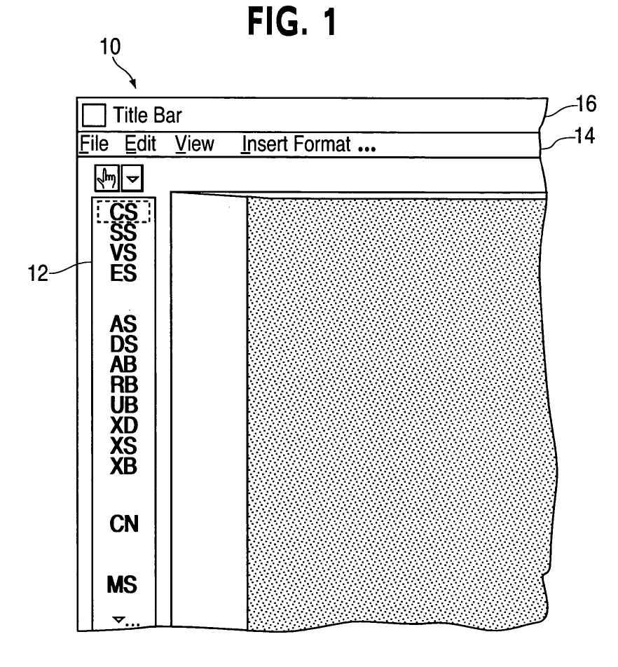

FIG. 1 is a representation of a screen display 10 within a graphical user interface (GUI), in which execution of a specific application by a microcomputer is shown. In the application, a representative vertically-oriented toolbar 12 associated with the application is displayed near the left edge of the display 10. The individual elements within the example toolbar 12 are presented tersely, in text abbreviation form. Abbreviation, whether in the manner shown, through the use of icons, or using a combination of text abbreviations and icons, can reduce the horizontal extent of a toolbar 12, when compared to presenting whole words or word strings to identify elements, for example. However, such display terseness provides an inexperienced user with little insight into the meaning of each element. Nonetheless, the operability of the toolbar 12 is complete, i.e., all functions that are not “grayed out” exist and can be executed, and a proficient user will likely find this configuration fully functional

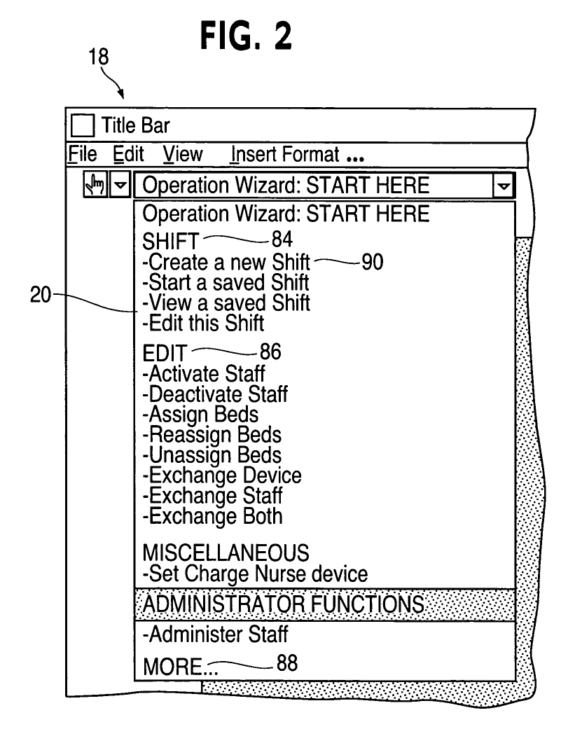

FIG. 2 shows a screen display 18 equivalent to that of FIG. 1, with the toolbar 12 of FIG. 1 hidden and a pull-down menu 20 displayed. The menu 20 of the example in FIG. 2 includes the same elements as the toolbar 12, in the same order, and at substantially the same vertical spacing. Having words or word strings for each element may be observed to obstruct view of more of the display, while offering little benefit to a proficient user. The menu 20 is a standard dropdown list, meaning that the menu 20 is in some embodiments hidden again after an item is selected for execution.

It is to be understood that hiding of a menu 20, as shown in FIG. 2, after selection of a command therefrom, is not a required property, but a characteristic of individual embodiments. Such a display presentation alternative may be established as a user-selectable option or fixed by a programmer.

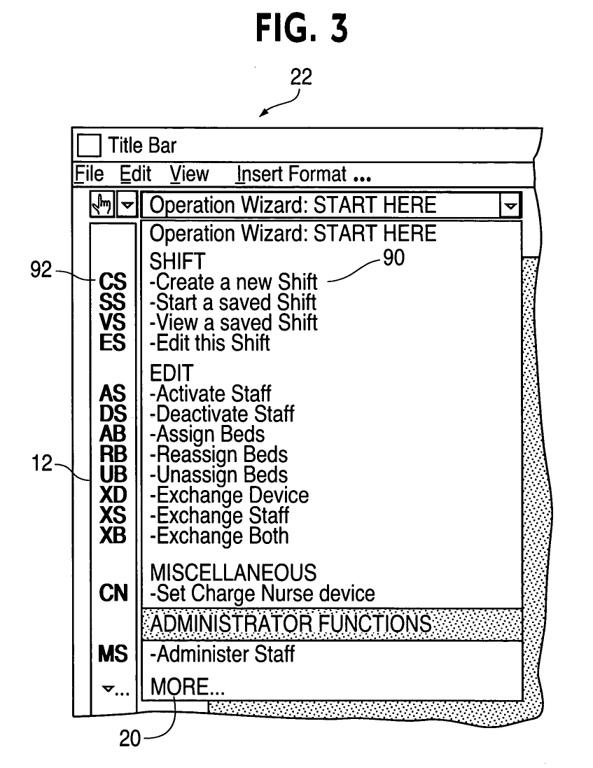

FIG. 3 shows a screen display 22 in which both the toolbar 12 and the pull-down menu 20 are displayed. Using the toolbar 12 or the menu 20 may thus be seen to be strongly operationally similar, with the equivalence of the two classes emphasized by the parallel organization of their respective presentations. The term “class” as used herein refers to access to software commands in a GUI environment, wherein user proficiency is a criterion, and use of a pull-down menu 20 involves a presumption of a lower requirement for user proficiency than access to the same commands by a toolbar 12. Thus, assignment of menu access to commands to a first class and assignment of toolbar access to commands to a second class allows display strategies to be differentiated according to user proficiency.

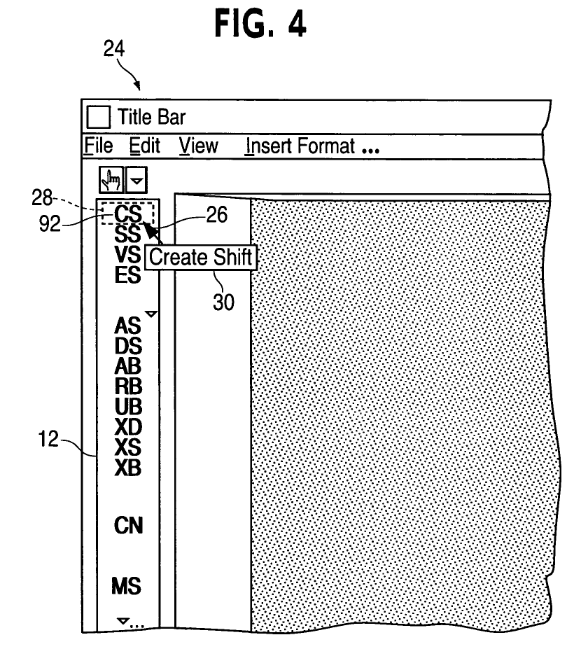

FIG. 4 shows a screen display 24 similar to the display in FIG. 1, in which only a toolbar 12 was activated. A GUI-compatible positioning input device, such as a mouse, trackball, joystick, and the like, can be used to position a cursor and thereby to control the selection of an item having a display position and an associated selection box, preparatory to issuing an activation command. A display position is the item's occupied region on the visible field of a display device, whether denoted in terms of center and geometric extent, starting coordinates and extent, starting and ending coordinates, or other denotation system. A selection box is the range of a positioning input device's focus over which the item is interpreted as being selected. In FIG. 4, a positioning input device has been used to cause a selection-locus indicator (“cursor”) 26 on the display to be positioned at and superimposed on (“hover over”) a location within the selection box 28 for a particular entry 92 in the toolbar 12.

The above event may conditionally allow a “screen tip” 30 to be displayed in the vicinity of the cursor 26, where the term “screen tip” 30 refers to an informational item such as a text display related to the element 92 hovered over. The user interface software, in the embodiment shown, is structured so that, if available, a screen tip 30 can be superimposed on the screen display 24 in the vicinity of the cursor 26 when the cursor's focus falls within the selection box 28 for an item.

It is to be understood that a visible item requires, within the display device, a display position large enough to allow a user to identify the item, and it is further to be understood that a selection box 28 generally corresponds to the display position of the item. Positioning of a cursor 26 so that its focus falls within the selection box 28 can, in some embodiments, be interpreted as constituting selection, although not activation, of the item.

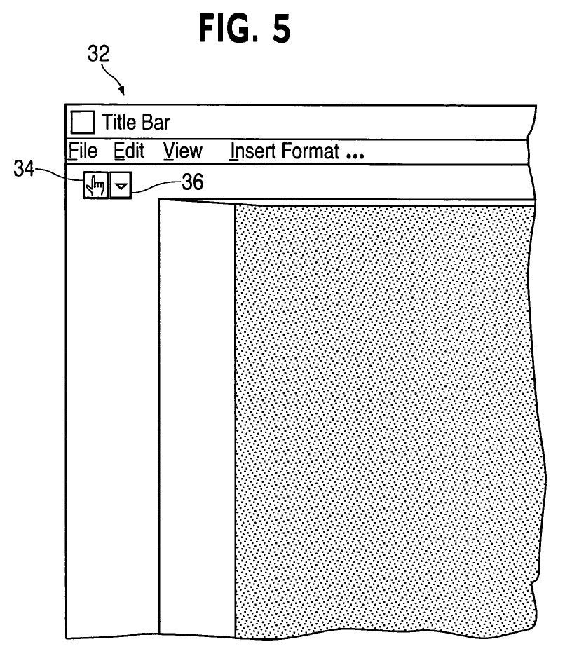

FIG. 5 shows an initial screen display 32 that can be presented to a user prior to the screen display 22 of FIG. 3. Here, the user is presented with a single icon-style soft key 34 (i.e., a simulated pushbutton within the GUI) showing, in this embodiment, a picture of a hand with an extended index finger, and further showing a down-arrow 36 adjacent to the soft key 34. The particular style of down-arrow 36 shown is known in some GUI systems for indicating access to a pull-down menu; in the embodiment shown, the down-arrow 36 provides access to a “user proficiency” pull-down menu, shown in the next figure.

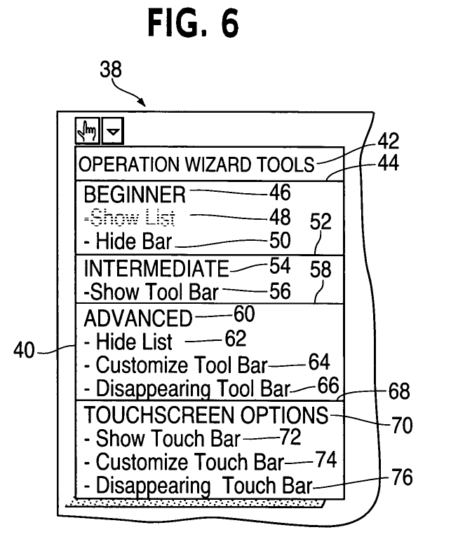

In FIG. 6, the screen display 38 shows a user proficiency pull-down menu 40, in which multiple items are presented. The top item is a title, OPERATION WIZARD TOOLS 42, not subject to activation. The next item, following a divider bar 44 in the embodiment shown, is a similarly nonactivatable subhead, BEGINNER 46, beneath which are two selectable items, Show List 48 and Hide Bars 50. For a novice user, toolbars may be confusing and thus undesirable, so that activating the Hide Bars 50 menu item may be preferred. Note that the Show List 48 menu item is “grayed out”—that is, the ostensibly selectable item is currently disabled, but is defined and may be enabled for selection in another operating mode. This is true in FIG. 6 because showing of the pull-down menu or list 12 in FIG. 3 has been selected previously. In other embodiments, functions already activated, such as the Show List 48 entry shown here, may be left in a normal display mode, if preferred.

Continuing down the list, following another divider bar 52, the nonactivateable subhead INTERMEDIATE 54 is followed by a single menu item, Show Tool Bar 56. This item is the reverse of the Hide Bars item 50; in the embodiment shown, this item is neither collocated with Hide Bars 50 nor provided in a toggle modality, again with a goal of making the process as obvious as possible for beginners. Toggling between Show Bar and Hide Bar in a single menu item—that is, providing a single menu item location, of which the meaning, and, in some embodiments, the displayed label, change between at least two values when activated—may be preferred in some embodiments, but can be less obvious, particularly to inexperienced or infrequent users. In the presentation shown, a self-recognizing BEGINNER is implicitly encouraged to select among items that are plausible, while a self-recognizing INTERMEDIATE user is similarly presented with and implicitly encouraged to select from items of a moderately advanced nature.

A third group in the list, following yet another divider bar 58 and another nonactivatable subhead, ADVANCED 60, includes selections Hide List 62, Customize Tool Bar 64, and Disappearing Tool Bar 66. Hide List 62 reverses Show List 48 under BEGINNER 46. The rationale for separation of the Show Bars/Hide Tool Bar menu pair applies to the Show List/Hide List menu pair as well, with the menu item more likely for the ADVANCED user positioned away from that intended for the BEGINNER. The second ADVANCED menu item, Customize Tool Bar 64, is offered to allow a sufficiently proficient user to arrange the content of tool bars to support personal preference. The final ADVANCED item, Disappearing Tool Bar 66, supports an additional mode in which a tool bar is hidden until the activation soft key 34 is selected, after which the tool bar is displayed only until an immediate need for it, such as to select one function, is finished.

Alternate terms may be preferred in some embodiments in place of BEGINNER, INTERMEDIATE, and ADVANCED, although the substance of providing menus alone, menus combined with toolbars, or toolbars alone can be retained with such alternate terms. It is to be understood that the presentation options of menus and toolbars as herein described are not limiting, but that other presentation options are possible. Presentation options for item selection can include display formats such as brief declarative statements for items and graphical examples corresponding to items, where sufficient display area exists to support such presentations. It is to be further understood that the display items can be shown individually, such as in response to a user's hovering a cursor over an option in a menu, where such presentation is preferable to continuous display of all items in a menu.

A fourth group in the list follows yet another divider bar 68 and another nonactivatable subhead, TOUCHSCREEN OPTIONS 70. This group addresses a specific hardware capability, namely support for touchscreen technology, which can be used in place of or in addition to keyboards, mice, touchpads, trackballs, joysticks, and other input devices.

As used herein, touchscreen technology refers to a data input technology in which a typical display device, such as a cathode ray tube (CRT) or liquid-crystal display (LCD) configured to support a GUI, is further configured to detect physical contact on its display surface, for example by provision of a substantially transparent and somewhat electrically conductive overlay grid. A typical touchscreen can detect finger position with a particular level of precision. The touchscreen may be somewhat affected by pressure, so that acquiring a signal level sufficient for activation may require that the user's fingertip be deflected (i.e., flattened) slightly, which can in turn provide tactile feedback to the user.

Other methods of integrating two-dimensional display and data input position grids are known, such as light pens, and various detection methods are known, including capacitance- and resistance-based sensing, acoustical ranging, and the like. Any method for superimposing an activation input directly on a region of a display rather than using a pointing device located away from the display is intended to be included under the general terms “touchscreen” and “touch-sensitive display device” for purposes of this disclosure.

A user's finger is an example of a “specified activating entity,” that is, a physical object or entity complying with a specification established by a vendor for applying an activating signal to a location on the display device. Like a menu or a toolbar, a touchbar associates a physical mapping of a display with a software mapping, so that at least one discretely detectable location on the touchscreen is mapped to a location listed in the software mapping, and activation of that location on the touchscreen results in issuance of an activation command by the software. Although alignment of a mouse-based system, for example, is relatively straightforward, alignment of touchscreen positioning with display positioning may be more complex, and may be less stable over time than mouse-based systems, as the display and the touch surface have independent sources of position error. Such disadvantages may be offset by advantages in some systems, so that use of touchscreen hardware in a system can be desirable.

The basis for discussion herein is that at least some touchscreen input devices may exhibit lower effective precision than some other types of pointing devices. Further, by relying on hand contact by users, some touchscreen devices occasionally operate with portions of the display obscured from view. While not true in all cases, these attributes, along with the usefulness of integrating display and input functions in a single interface element, reveal a desirable aspect of list-bar-capable software applications, namely accommodation of lower-resolution position input.

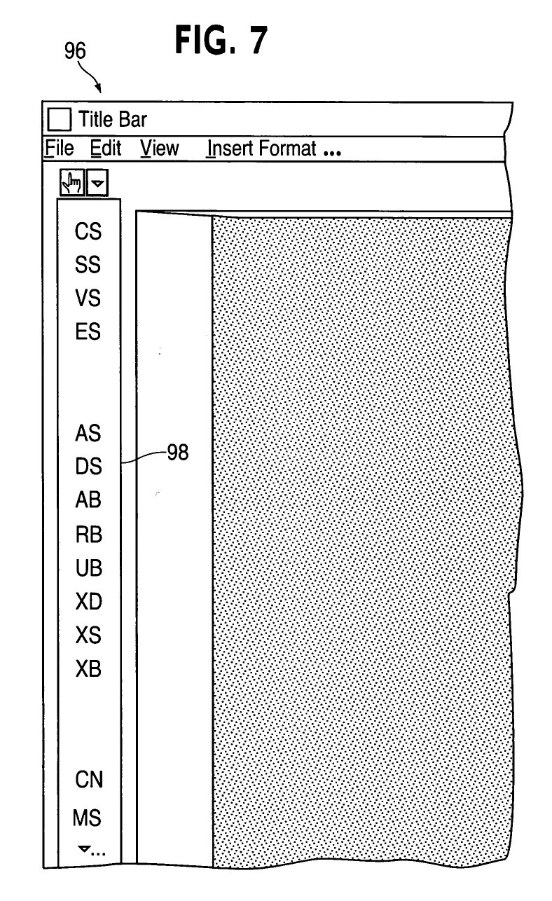

The TOUCHSCREEN OPTIONS 70 group in the embodiment shown includes Show Touch Bar 72, Customize Touch Bar 74, and Disappearing Touch Bar 76. Activation of Show Touch Bar 72 can replace a standard toolbar with a touchbar, on which substantially the same elements are displayed, but with different (typically wider) spacing between elements. This will be shown in FIG. 7. Cancellation of Show Touch Bar 72 is provided in the embodiment shown by activation of the Hide Bars 50 menu item in the BEGINNER 46 group, shown in FIG. 6. Activation of Customize Touch Bar 74 has substantially the same sense as Customize Tool Bar 64 in the ADVANCED 60 group, with additional customization capability based on the differing attributes of various touchscreen hardware embodiments. The final option in the TOUCHSCREEN OPTIONS 70 group is Disappearing Touch Bar 76, which is analogous to the Disappearing Tool Bar 66 function under ADVANCED 60.

The examples discussed below are related to a single case application for list-bar capability. As such, the examples illustrate the characteristics of the inventive technology and imply the software requirements for incorporating list-bar capability into a GUI-based software application.

It is to be understood that the term “vertically oriented” as used herein refers to a pull-down or pop-up menu, toolbar, or touchbar in which executable items from a list are presented for selection as successive entries in a display field, where a next list item is positioned below a previous list item, with successive list items in a range simultaneously visible. Such a presentation is suited to languages such as English, Urdu, Russian, Arabic, and other writing systems that are left-to-right or right-to-left reading by default. Vertically-oriented writing systems such as Mandarin may be preferentially supported with horizontally-oriented menu systems. In both orientations of writing systems, toolbars may be oriented vertically or horizontally according to preference. A “pull-down” is commonly associated with an identifying element at or near the top of a display or of a GUI process within a display, wherein selection of the identifying element causes the pull-down to be displayed, and wherein the upper extent of the pull-down is typically located approximately at the location of the identifying element, whereas a “pop-up” may be located elsewhere in a display, such as with its first or last element adjacent to the pointing device symbol on the display.

The toolbars and touchbars shown in the figures herein are vertically oriented for compatibility with menus, and use text abbreviations rather than icons to represent functions. It is to be understood that alternative orientations and function representations may be present in some embodiments. Placement of a menu and an associated toolbar adjacent and parallel to one another, with spacings between corresponding items in the menu and toolbar that are approximately equal, can aid in learning the equivalence between the two representations, and may thus be preferable. The use of icons—that is, graphical images that can function as “visual mnemonics”—rather than text abbreviations for one or more functions in a toolbar, may likewise be preferable in some embodiments.

Returning to FIG. 2, the screen display 18 shows that a user has started an application, the purpose of which is to perform, by way of example, hospital administration at the level of creating, altering, viewing, and executing work shifts. Note that the term “shift” may apply to a one-time event or an event that repeats, for example, every week, which would be clear to a user in context but need have no effect on the example. The application is used for assigning and deassigning staff members by shift, associating and disassociating beds with those staff members, and a variety of other functions. The screen display 18 shows only a pulldown menu 20, so it may be inferred that the function Operation Wizard Tools 42, shown in FIG. 6, is currently functioning in the BEGINNER 46 mode discussed above. In FIG. 2, functions within the application include SHIFT 84 functions, EDIT 86 functions, and others, along with a continuation function MORE . . . 88. Each of the executable menu entries, such as -Create a New Shift 90, is typically more descriptive than a toolbar 12 entry, as shown in FIG. 1. Particularly when presented in conjunction with group subheads 84, 86, 80, and the like, list-formatted groups of menu 20 items may provide contextualized meaning, rendering the presentation more effective than that of individual screen tips 30, shown in FIG. 4.

Returning to FIG. 3, the screen display 22 shows the same application as FIGS. 1 and 2, but the pull-down menu 20 is now augmented with a vertically-oriented toolbar 12, in which executable pull-down menu entries, such as -Create a New Shift 90, are aligned with corresponding toolbar items, such as CS 92. It may be inferred that the function Operation Wizard Tools 42, shown in FIG. 6, is currently functioning in the INTERMEDIATE 54 mode discussed above. In FIG. 3, it is evident that the toolbar 12 entry CS 92, corresponding to -Create a New Shift 90, is sufficiently terse that a learning cycle may be required. Nonetheless, repeated use is likely to render the pull-down menu 20 redundant for at least some users.

Returning to FIG. 4, the screen display 24 shows the same application, with only the vertically-oriented toolbar 12 visible. With a cursor 26 hovering over CS 92 as shown, the screen tip Create Shift 30 is displayed. Thus it may be inferred that the function Operation Wizard Tools 42, shown in FIG. 6, is currently functioning in the ADVANCED 60 mode discussed above, and that the display of screen tips is enabled.

FIG. 7 shows a screen display 96 on which a touchbar 98 is presented in place of the toolbar 12 of FIG. 4. It is evident that a noticeable difference between the screen displays is spacing between elements. Thus it may be inferred that the function Operation Wizard Tools 42, shown in FIG. 6, is currently functioning in the TOUCHSCREEN OPTIONS 70 mode discussed above, with Show Touch Bar 72 activated.

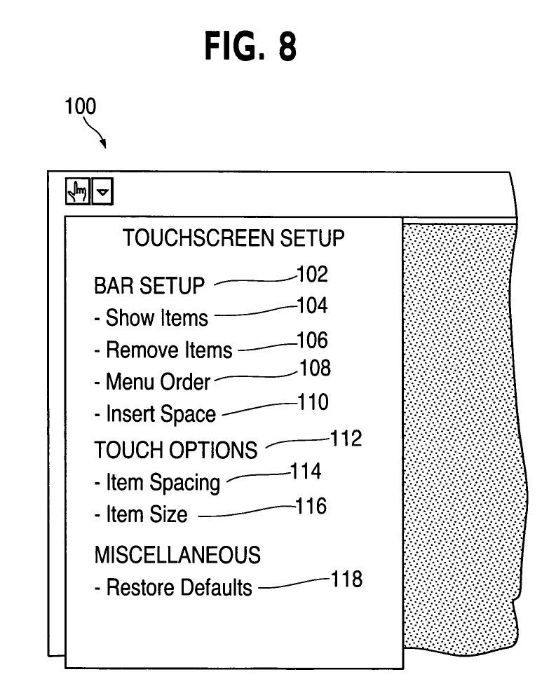

FIG. 8 shows a screen display for TOUCHSCREEN SETUP 100, in which the options in the Customize Touch Bar 74 function of FIG. 6 can be set. Here, layout of each touchbar displayed on a touchscreen can be adjusted, with individual or group options available as appropriate in an embodiment. Under BAR SETUP 102, tools -Show Items 104, -Remove Items 106, -Menu Order 108, and -Insert Space 110 can be provided to allow selectable functions corresponding to menu items to be presented in an alternative order, concealed, or separated to a different extent than in the menu on which the touchbar is based. In typical embodiments, menu items can be assigned attributes of visibility, default order, edited order, and the like, so that changes under BAR SETUP 102 can be made readily. Under TOUCH OPTIONS 112, tools -Item Spacing 114 and -Item Size 116 can be provided to accommodate a number of selectable menu items to a specific display size and resolution, either globally or for each menu. The Restore Defaults 118 tool can be provided to return to the menu selection originally provided, using the above-referenced assigned attributes.

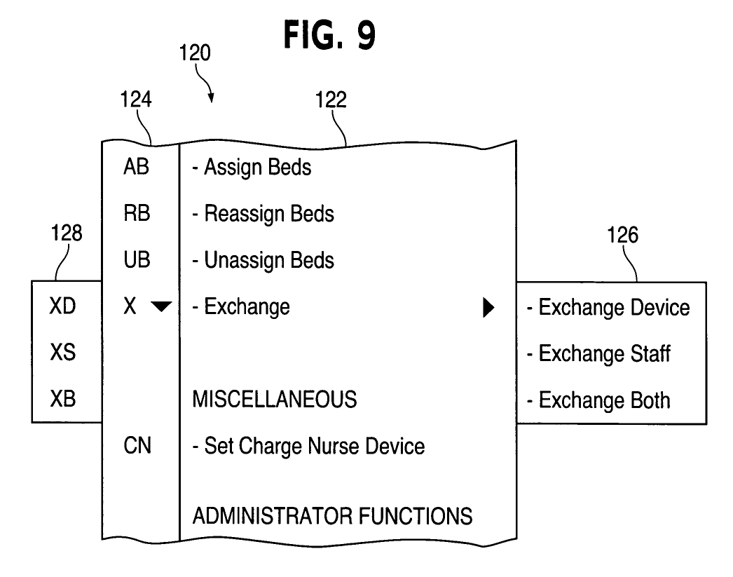

FIG. 9 shows a list-bar presentation 120 using a portion of the list-bar presentation of FIG. 3, modified to illustrate a pull-down menu 122 and a corresponding toolbar 124 that have cascaded elements. As shown, menu sub-elements 126 and toolbar sub-elements 128 each cascade to a respective default side if sufficient display space exists. Cascading to an opposite side or displacement of the entire cascading list-bar is possible if a proximal display edge prevents default display 120.

List-bar user interface control may be most readily applied to computer systems intended for users who are fully able to access typical resources, including at least a video display device, a keyboard, and a mouse or touch screen, as well as a sound generator. For users with reduced visual or aural acuity, range of motion, reading comprehension, and the like, the concept of list-bar user interface control may be nonetheless usable when appropriately adapted.

For a low-mobility user, for example, jumping to a preferred selection group in FIG. 6 may be simplified to a combination of user pauses and actuations of a “puff-and-sip” input device. For such a user, choosing an entry within a selection group may be simplified to a sequence in which the user steps through highlighted options, pauses at a particular option, receives a visual or audible prompt from the system, and confirms the selection by responding within a time window. Similar adaptation to other user functional limitations is equally possible.

Affirming user identity in a privacy or security sensitive environment restricted to trusted users may be similarly enhanced by comparing a present-session pattern of use to one or more patterns of use stored from previous sessions. Such an application of list-bar user interface control could, for example, begin execution of a session using a list-bar aware application as though list-bar capability were not supported, for example using BEGINNER mode, and a pattern of menu use could be compared to a user's previously established preferences while the session proceeded, in order to establish a confidence score regarding the identity of the user.

List-bar user interface control as shown is useful in improving and maintaining user proficiency with many types of software, including such tasks as the creation, interrogation, and modification of databases by health care facilities, schools, repair shops, and other users who may be concerned with ease of use and prevention of mistakes. List-bar capability can be used in many environments, such as manufacturing, warehousing, and food service, where speed and reliability may be principal considerations. It can find further application in military, law enforcement, courthouse, airline passenger support, and other environments where security may be a determining factor.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to that fall within the scope of the invention.

1. A method of displaying and processing information on a display device as proficiency in a program is achieved, the method comprising:
providing a group of elements for display on the display device component of an interface subsystem of a computing device, wherein each of the elements is configured to execute a function in the program associated with the computing device;
identifying a first class of selectable elements within the group of elements, wherein the first class of selectable elements comprise a menu;
identifying a second class of selectable elements within the group of elements, wherein the second class of selectable elements comprise a toolbar, and wherein individual selectable elements of the second class correspond to individual selectable elements of the first class in both position and functionality;
executing the functions in the program upon selection of at least one selected from the group consisting of the first class of selectable elements and the second class of selectable elements; and
selectably concealing a class of selectable elements from the display device as familiarity with the program advances, wherein the concealed class is selected from the group consisting of the first class and the second class.

2. The method of displaying and processing information of claim 1, further comprising:
providing a positionable display device location indicator whereby an executable function represented by a selectable element on a display device is selected; and
providing an executable function activator whereby an executable function represented by a selectable element on a display device is commanded to execute.

3. The method of displaying and processing information of claim 2, further comprising:
associating the menu class of selectable elements and the toolbar class of selectable elements with different user proficiency levels;
providing a display format selection mechanism enabling a user to select between menu and toolbar classes of selectable elements in accordance with the user's proficiency level; and
providing a display format selection mechanism enabling a user to select an intermediate proficiency level, wherein both menu and toolbar classes of selectable elements are presented for selection.

4. The method of displaying and processing information of claim 3, further comprising:
providing a pull-down property whereby no selection element classes are displayed prior to activation of a menu summary list item; and
providing a persistence property for displayed classes of selectable elements, wherein the persistence property is selected from the group consisting of continuously displayed and concealed after activation of an executable function represented by a selectable element.

5. The method of displaying and processing information of claim 4, further comprising providing a group of nonexecutable, nonselectable display elements, wherein display of nonselectable elements is interspersed with display of selectable display elements in a selection element class.

6. The method of displaying and processing information of claim 5, wherein the elements of the group of nonexecutable, nonselectable display elements provide information augmenting the information content of the selectable elements.

7. The method of displaying and processing information of claim 6, further comprising:
providing a plurality of user-invokable executable functions in a program having a plurality of program states;
disabling from selection those functions in the plurality of functions for which execution is excluded in a program state; and
displaying with distinctive appearance those functions that are disabled in a program state.

8. The method of displaying and processing information of claim 4, further comprising:
providing a list option for touchpad presentation as a user-selectable display mode; and
adjusting a toolbar presentation to accommodate a touchpad functional mode.

9. The method of displaying and processing information of claim 8, further comprising:
providing a customization function for touchpad presentation, wherein the customization function allows distance between elements to be a user-changeable characteristic of the touchpad presentation; and
providing a plurality of size options for a touchpad element.

10. An information acquisition, maintenance, and display system, comprising:
means for displaying a group of elements at display locations on a display device component of an interface subsystem of a computing device, wherein each of the elements is configured to execute a function in the program associated with the computing device;
means for identifying a first class of selectable elements within the group of elements, wherein the first class of selectable elements comprise a menu;
means for identifying a second class of selectable elements within the group of elements, wherein the second class of selectable elements comprise a toolbar, and wherein individual selectable elements of the second class correspond to individual selectable elements of the first class in both position and functionality; and
means for selectably concealing a class of selectable elements from the display device as familiarity with the program advances, wherein the concealed class is selected from the group consisting of the first class and the second class.

11. The information acquisition, maintenance, and display system of claim 10, further comprising:
means for indicating a location on the display device, whereby an executable function represented by a selectable element displayed at the location on the display device is selected; and
means for activating the executable function selected by the means for indicating a location.

12. The information acquisition, maintenance, and display system of claim 11, further comprising:
means for establishing a plurality of system interface display and user interface operating modes;
means for correlating each mode to a user proficiency level; and
means for selecting a mode from the plurality of modes.

13. The information acquisition, maintenance, and display system of claim 12, further comprising:
means for associating a physical region on a touch-sensitive display device with a region in a software mapping of the touch-sensitive display device, whereby contact by a specified activating entity onto the touch-sensitive display device, within the physical region, activates a software function associated with the region in the software mapping; and
means for altering dimensions and locations of a plurality of physical regions on a touch-sensitive display device associated with a plurality of software function activation mappings in the display software.

14. The information acquisition, maintenance, and display system of claim 13, further comprising:
means for modifying an attribute within a list of display attributes associated with a display mode; and
means for employing a modified list of display attributes in generating a display image.

15. A computer readable medium with program instructions for displaying and processing information, comprising the instructions for:
providing a group of elements for display on the display device component of an interface subsystem of a computing device, wherein each of the elements is configured to execute a function in the program associated with the computing device;
identifying a first class of selectable elements within the group of elements, wherein the first class of selectable elements comprise a menu;
identifying a second class of selectable elements within the group of elements, wherein the second class of selectable elements comprise a toolbar, and wherein individual selectable elements of the second class correspond to individual selectable elements of the first class in both position and functionality;
executing the functions in the program upon selection of at least one selected from the group consisting of the first class of selectable elements and the second class of selectable elements; and
selectably concealing a class of selectable elements from the display device as familiarity with the program advances, wherein the concealed class is selected from the group consisting of the first class and the second class.

16. The computer readable medium with program instructions for displaying and processing information of claim 15, further comprising the instructions for:
providing a pull-down property whereby no selection element classes are displayed prior to activation of a menu summary list item; and
providing a persistence property for displayed classes of selectable elements, wherein the persistence property is selected from the group consisting of continuously displayed and concealed after activation of an executable function represented by a selectable element.

17. The computer readable medium with program instructions for displaying and processing information of claim 16, further comprising the instructions for:
presenting a user-activatable display control access function;
displaying on demand user-activatable display control selection options; and
changing display appearance to conform to user display control selections.

18. The computer readable medium with program instructions for displaying and processing information of claim 17, further comprising the instructions for:
identifying selected options by distinctive presentation thereof; and
displaying non-user-activatable section heading elements.

19. The computer readable medium with program instructions for displaying and processing information of claim 16, further comprising the instructions for:
supporting input of selection and activation information from a touchscreen used as a pointing device;
setting display element dimensions and positions for compatibility with a fineness of resolution characteristic of the touchscreen; and
calibrating position information from the touchscreen for coordination with display positions.

20. An apparatus for increasing proficiency in a software program located on a computer processing device by altering items presented on a display, the apparatus comprising:
a menu comprising at least one selectable, executable function displayed in a menu format;
a toolbar comprising at least one selectable, executable function displayed in a toolbar format, wherein the at least one executable function displayed in the toolbar format is substantially equivalent to and is positioned substantially in parallel with the at least one executable function displayed in the menu format;
a proficiency tool configured to permit alteration of the display such that as user efficiency is increased, toolbar availability substantially increases, and, whereinafter, as user efficiency is further increased, menu availability substantially decreases.

21. The apparatus of claim 20, wherein the apparatus further comprises at least one of:
a processing device;
an input/output interface for the processing device;
an information storage and retrieval unit providing modifiable record keeping for the processing device;
a processor-based instruction sequence actuating the processing device to control the interface unit and the information storage and retrieval unit; and
a two-dimensional display output device supporting presentation of a visible image having at least two distinct levels of visual intensity;
a keyboard-equivalent input device;
a position-indicating device configured as an input device to provide a position indication correlated to a location on the visible image on the display output device; and
an activation device configured as an input device to provide an activation signal.

22. The apparatus of claim 21, wherein the input/output interface further comprises a processor-compatible touch-sensitive surface superimposed on the visible image presented on the display output device, wherein the touch-sensitive surface is configured to provide a data output signal representing a location on the surface on which a touch occurs, and wherein a mapping correlates the set of display elements and a set of touch-sensitive locations on the surface, whereby a touch applied to the surface is interpretable as both a position indication and an activation signal.
